(19) United States
(12) Patent Application Publication
(10) Pub. No.: US 2016/0241758 A1
(43) Pub. Date: Aug. 18, 2016

(54) FLUORESCENCE MICROSCOPE

(71) Applicant: OLYMPUS CORPORATION, Tokyo (JP)

(72) Inventors: Masahito DOHI, Tokyo (JP); Yu KIKUCHI, Tokyo (JP)

(73) Assignee: OLYMPUS CORPORATION, Tokyo (JP)

(21) Appl. No.: 15/041,330

(22) Filed: Feb. 11, 2016

(30) Foreign Application Priority Data
Feb. 18, 2015 (JP) 2015-029624

(51) Int. Cl. H04N 5/225; G02B 21/16; G02B 21/36; H04N 5/232

(52) U.S. Cl. CPC H04N 5/2256; H04N 5/232; H04N 5/2254; G02B 21/16; G02B 21/361

(57) ABSTRACT

An object of the present invention is to obtain clear images when observing a specimen at different positions in the optical-axis direction of a detection optical system, using the sheet illumination. A fluorescence microscope of the present invention includes a sheet-illumination optical system that causes sheet-like excitation light along a plane of incidence to be incident on a specimen; an image-acquisition optical system that includes an objective lens having an optical axis intersecting the plane of incidence and that images fluorescence collected by the objective lens to obtain a fluorescence image; a driving part that moves the specimen in the optical-axis direction of the objective lens; and a positional-shift correction unit that, when a focus position of the image-acquisition optical system relative to an illumination position of the excitation light changes due to movement of the specimen in the optical-axis direction by the driving part, corrects a positional shift between the illumination position of the excitation light and the focus position of the image-acquisition optical system.

### CROSS-REFERENCE TO RELATED APPLICATIONS

This application is based on Japanese Patent Application No. 2015-029624, the contents of which are incorporated herein by reference.

### TECHNICAL FIELD

The present invention relates to fluorescence microscopes.

### BACKGROUND ART

In the related art, there are known fluorescence microscopes of the sheet-illumination type, in which a specimen is irradiated with excitation light along a plane of incidence perpendicular to the optical axis of a detection optical system that detects fluorescence from the specimen (for example, see Patent Literature 1). In epi-illumination or transillumination types, a two-dimensional image is acquired by two-dimensionally scanning excitation light focused at a single point or a plurality of points; however, with the sheet-illumination type, a wide area of the specimen can be illuminated at one time, and the time required for obtaining an image of a comparatively large specimen can thus be shortened.

### CITATION LIST

### Patent Literature

### PTL 1

Publication of Japanese Patent No. 5525136

### SUMMARY OF INVENTION

In a conventional fluorescence microscope of the sheet-illumination type, when tomographic images of the specimen are obtained while moving the specimen in the optical axis direction of the detection optical system, to attempt to observe a larger specimen, the system cannot deal with shifts in the focal position of the detection optical system due to changes in the refractive index distribution from the detection optical system to the illumination position of the excitation light.

In other words, when the specimen is moved in the optical axis direction of the detection optical system, the focus position of the detection optical system changes due to changes in the proportions of the thicknesses of individual layers along the optical-axis direction of multiple media, which have different refractive indices, that exist from the detection optical system to the excitation light irradiation position in the optical axis direction. As a result, a shift occurs between the excitation light irradiation position and the focus position of the detection optical system, and clear images cannot be obtained.

The present invention provides a fluorescence microscope that can obtain clear images when observing different positions in a specimen, in the optical axis direction of the detection optical system, using sheet illumination.

A first aspect of the present invention is a fluorescence microscope including: a sheet-illumination optical system that causes sheet-like excitation light along a plane of incidence to be incident on a specimen; an image-acquisition optical system that includes an objective lens having an optical axis intersecting the plane of incidence and that images fluorescence collected by the objective lens to obtain a fluorescence image; a driving part that moves the specimen in the optical-axis direction of the objective lens; and a positional-shift correction unit that, when a focus position the image-acquisition optical system relative to an illumination position of the excitation light changes due to movement of the specimen in the optical-axis direction by the driving part, corrects a positional shift between the illumination position of the excitation light and the focus position of the image-acquisition optical system.

With this embodiment, when the sheet-like excitation light along the plane of incidence is incident on the specimen, a fluorescent substance inside the specimen, disposed at the middle in the thickness of the sheet-like excitation light, is excited, and fluorescence is generated. Then, of the generated fluorescence, the fluorescence collected by the objective lens is imaged by the image-acquisition optical system, whereby a fluorescence image is obtained. Therefore, it is possible to illuminate, at the same time, a wide region in a direction intersecting the optical axis of the objective lens, and the time required for obtaining an image of a comparatively large specimen can thus be shortened. In addition, by moving the specimen in the optical-axis direction of the objective lens by the operation of the driving part, it is possible to obtain different tomographic images in the specimen in the optical-axis direction of the objective lens.

In this case, when the specimen moves in the optical-axis direction of the objective lens, the proportions of the thicknesses, in the optical-axis direction, of the plurality of media having different refractive indices which are interposed from the objective lens to the illumination position of the excitation light in the optical-axis direction change, whereby the focus position of the image-acquisition optical system relative to the illumination position of the excitation light changes. To counter this, when the focus position of the image-acquisition optical system relative to the illumination position of the excitation light changes, by correcting the positional shift between the illumination position of the excitation light and the focus position of the image-acquisition optical system with the positional-shift correction unit, it is possible to obtain clear images even when the observation position in the optical-axis direction in the specimen changes. Therefore, clear images of different positions in the optical-axis direction of the objective lens can be obtained, and it is possible to observe a larger specimen.

In the above-described aspect, the positional-shift correction unit may adjust the position of the objective lens in the optical-axis direction so that the focus position of the image-acquisition optical system is aligned with the illumination position of the excitation light.

With this configuration, it is possible to obtain a clear image at the changed observation position via a simple method in which the position of the objective lens is merely shifted in the optical-axis direction by the amount by which the focus position of the image-acquisition, shifts relative to the illumination position of the excitation light.

In the above-described aspect, the objective lens may be a variable-focus objective lens capable of changing the focus position of the image-acquisition optical system by application of a voltage, and the positional-shift correction unit may control the voltage applied to the variable-focus lens so that the focus position of the image-acquisition optical system. is aligned with the illumination position of the excitation light.

With this configuration, since an optical system, such as the objective lens, is not moved in the optical-axis direction, light is blocked for darkening the surroundings, which facilitates observation.

In the above-described aspect, the positional-shift correction unit may include a pair of wedge-shaped wedge members having different refractive indexes according to the thicknesses thereof and a wedge-member control unit that is capable of symmetrically moving the pair of wedge members in directions intersecting the optical axis of the objective lens, and the wedge-member control unit may adjust positions at which the fluorescence collected by the objective lens passes through each wedge member so that the focus position of the image-acquisition optical system is aligned with the illumination position of the excitation light.

With this configuration, since the focus position of the image-acquisition optical system changes in the axial direction of the objective lens according to the thicknesses of the wedge members at the positions where the light collected by the objective lens passes through, it is possible to align the focus position of the image-acquisition optical system with the illumination position of the excitation light simply by adjusting the positions of the pair of wedge members with the wedge-member control unit.

In the above-described aspect, the positional-shift correction unit may adjust the illumination position of the excitation light in the optical-axis direction so that the illumination position of the excitation light is aligned with the focus position of the image-acquisition optical system.

With this configuration, so long as the specimen is moved in the optical-axis direction of the objective lens, by taking account of the amount of change in the focus position of the image-acquisition optical system relative to the illumination position of the excitation light, merely by shifting the illumination position of the excitation light in the optical-axis direction by the amount by which the focus position of the image-acquisition optical system has shifted relative to the illumination position of the excitation light, it is possible to obtain a clear image at the desired observation position.

A second aspect of the present invention is a fluorescence microscope including: a sheet-illumination optical system that causes sheet-like excitation light along a plane of incidence to be incident on a specimen; an image-acquisition optical system that includes an objective lens having an optical axis intersecting the plane of incidence and that images fluorescence collected by the objective lens to obtain a fluorescence image; a driving part that moves the specimen in the optical-axis direction of the objective lens; and a proportion-maintaining part that maintains constant proportions of the thicknesses, in the optical-axis direction, of a plurality of media having different refractive indices which are interposed between the objective lens and the illumination position of the excitation light, regardless of the movement of the specimen in the optical-axis direction by the driving part.

With this embodiment, since the proportions of the thicknesses, in the optical-axis direction, of the plurality of media having different refractive indices which are interposed from the objective lens to the illumination position of the excitation light in the optical-axis direction are kept constant by the proportion-maintaining part even if the specimen is moved in the optical-axis direction of the objective lens, the occurrence of a shift between the illumination position of the excitation light and the focus position of the image-acquisition optical system can be prevented. Therefore, it is possible to obtain a clear image regardless of the observation position in the specimen, in the optical-axis direction of the image-acquisition optical system, and it is possible to obtain clear tomographic images at different positions in the optical-axis direction of the objective lens and to observe a larger specimen.

The above-described aspect may further include a container that can contain the specimen in a medium having a refractive index close to the refractive index of the specimen, wherein the proportion-maintaining part is through which the fluorescence can pass, and which is fitted on the objective lens to form a fixed space in the optical-axis direction from the objective lens, and the driving part moves the specimen in a state in which. the cap is inserted in the medium in the container.

With this configuration, when the cap is inserted in the medium in the container which contains the specimen, in a state in which the cap is fitted on the objective lens, an air (medium) layer due to the cap, as well as a medium layer and a specimen (medium) layer in the container, are formed between the objective lens and the illumination position of the excitation light. The refractive indices of the medium and the specimen in the container are close to each other, and therefore, so long as the objective lens is moved in the optical-axis direction together with the cap while the cap is inserted in the medium inside the container, the proportions of the thicknesses of the air layer and the medium and specimen layer in the container do not change.

Therefore, with a simple configuration in which observation is performed with the specimen is contained in the medium inside the container, the cap is fitted on the objective lens, the cap is inserted into the medium inside the container, and observation is performed, it is possible to prevent a shift between the illumination position of the excitation light and the focus position of the image-acquisition optical system due to the movement of the specimen in the optical-axis direction of the objective lens, and thus clear image acquisition can be realized.

The present invention affords an advantage in that it is possible to obtain a clear image when observing different positions in a specimen, in the optical axis direction of the detection optical system, using sheet illumination.

### BRIEF DESCRIPTION OF DRAWINGS

FIG. 1 is a diagram showing, in outline, the configuration of a fluorescence microscope according to a first embodiment of the present invention.

FIG. 2 is a diagram showing, in outline, the configuration of a sheet-illumination optical system and an image-acquisition optical system in FIG. 1.

FIG. 3 is a diagram showing the relationship between the focal length of the objective lens and the thicknesses of an air layer and a water layer.

FIG. 4A is a diagram showing a state in which an excitation light illumination position and a focus position of the image-acquisition optical system are aligned.

FIG. 4B is a diagram showing a state in which there is a positional shift between the excitation light illumination position and the focal position of the image-acquisition optical system due to movement of the specimen.

FIG. 5 is a diagram showing a configuration for adjusting the focal position by moving the image-acquisition optical system in the optical-axis direction.

FIG. 6 is a diagram showing a configuration for adjusting the focus position with a variable-focus objective lens in a fluorescence microscope according to a first modification of the first embodiment of the present invention.

FIG. 7 is a diagram showing a configuration for adjusting the focus position with wedge members in a fluorescence microscope according to a second modification of the first embodiment of the present invention.

FIG. 8 is a diagram showing a configuration for adjusting the focus position by adjusting the excitation light illumination position in a fluorescence microscope according to a third modification of the first embodiment of the present invention.

FIG. 9 is a diagram showing, in outline, the configuration of an image-acquisition optical system in a fluorescence microscope according to a second embodiment of the present invention.

### DESCRIPTION OF EMBODIMENTS

### First Embodiment

A fluorescence microscope according to a first embodiment of the present invention will be described below with reference to the drawings.

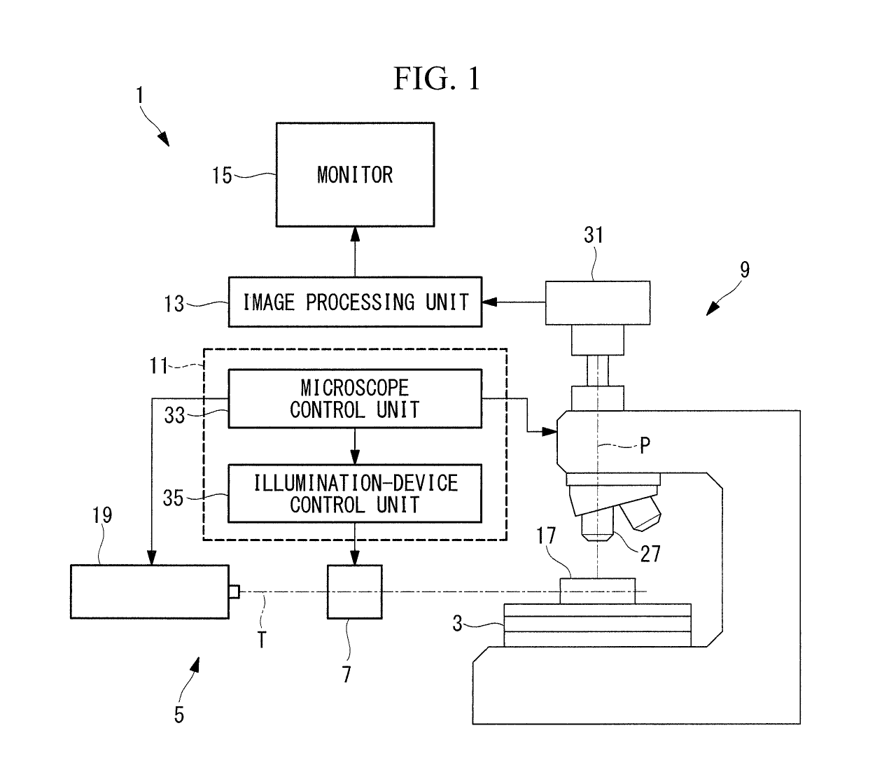

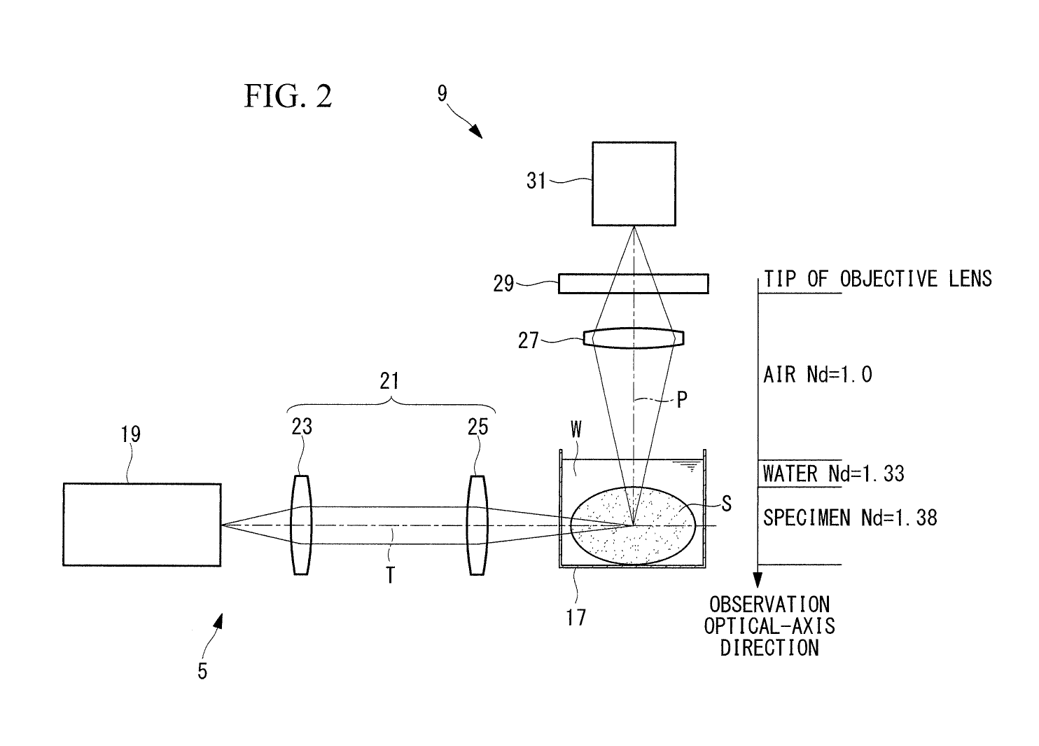

As shown in FIG. 1, the fluorescence microscope 1 according to this embodiment includes a stage 3 on which a specimen S (see FIG. 2) is mounted; a sheet-illumination optical system 5 that causes sheet-like excitation light along a plane of incidence T to be incident on the specimen S on the stage 3; a shifter 7 that can shift the excitation light in a direction perpendicular to the plane of incidence T; an image-acquisition optical system 9 that has an optical axis P that extends in the vertical direction and that obtains an image (fluorescence image) of the specimen S; a control device 11 that controls the stage 3, the sheet-illumination optical system 5, the shifter 7, and the image-acquisition optical system 9; an image processing unit 13 that processes an image obtained by the image-acquisition optical system 9; and a monitor 15 that displays the image processed by the image processing unit 13.

As shown in FIG. 1 and FIG. 2, the specimen S is contained in a container 17 mounted on the stage 3. The container 17 is filled with water (medium) W. The container 17 is formed of a material that can transmit the excitation light incident thereon along the plane of incidence T from the sheet-illumination optical system 5. In addition, the container 17 is open at the top thereof in the vertical direction.

The height of the stage 3 in the vertical direction can be varied by a driving part (not illustrated). By doing so, the specimen S mounted on the stage 3 can be moved in the optical-axis direction of the image-acquisition optical system 9.

As shown in FIG. 2, the sheet-illumination optical system 5 is provided with an excitation light source 19 that emits excitation light and a lens group 21 that converts the excitation light emitted from the excitation light source 19 into the sheet-like light.

The lens group 21 includes, for example, a collimator lens 23 that converts the excitation light emitted from the excitation light source 19 into substantially collimated light and a cylindrical lens 25 that focuses the excitation light converted to substantially collimated light by the collimator lens 23 to convert it to sheet-like light.

The cylindrical lens 25 has power only in the optical axis P direction of the image-acquisition optical system 9. This cylindrical lens 25 focuses the excitation light in the vertical direction so as to convert the excitation light sheet-like light that is incident on the specimen S along the plane of incidence T, which extends in the horizontal direction.

The shifter 7 is formed of a parallel flat glass plate and can be inserted in and removed from the light path of the excitation light between the cylindrical lens 25 and the specimen S. This shifter 7 is inserted in the light path in a state in which it is inclined relative to the plane of incidence T of the excitation light, thereby making it possible to move the excitation light in a direction perpendicular to the plane of incidence T by an amount of variation according to the inclination angle of the shifter 7. In other words, when the state is changed from the state in which the shifter 7 is not inserted to the state in which the shifter 7 is inserted, the excitation light shifts in the vertical direction by a prescribed amount of variation.

The image-acquisition optical system 9 is disposed facing the specimen S and vertically above the specimen S mounted on the stage 3. This image-acquisition optical system 9 includes an objective lens 27 that has an optical axis P and collects light from the specimen S, a BA filter (barrier filter) 29 that removes excitation light included in the light collected by the objective lens 27, and an image-acquisition element 31, such as a CCD, that images the fluorescence that has passed through the BA filter 29 to obtain an image. The objective lens 27, the BA filter 29, and the image-acquisition element 31 can be moved as a single unit in the vertical direction.

As shown in FIG. 1, the control apparatus 11 includes a microscope control unit (positional shift correction unit) 33 that controls the stage 3, the sheet-illumination optical system 5, and the image-acquisition optical system 9, and an illumination-device control unit 35 that controls the insertion/removal of the shifter 7.

The microscope control unit 33 changes the height of the stage 3 so as to move the specimen S in the optical-axis direction of the objective lens 27. When a shift occurs between the excitation light illumination, position and the focus position of the image-acquisition optical system 9 due to the movement of the specimen S in the optical-axis direction of the objective lens 27 by the stage 3, the microscope control unit 33 adjusts the position in the optical-axis direction of the objective lens 27 to correct the positional shift between the excitation light illumination position and the focus position of the image-acquisition optical system 9.

Specifically, the microscope control unit 33 moves the image-acquisition optical system 9 in the optical-axis direction of the objective lens 27 by an amount corresponding to the shift in focus position of the image-acquisition optical system 9 relative to the excitation light illumination position due to the movement of the specimen S in the optical-axis direction of the objective lens 27.

The amount of shift in the focus position of the image-acquisition optical system 9 relative to the excitation light illumination position, in other words, the amount by which the image-acquisition optical system 9 is moved in the optical-axis direction, can be calculated on the basis of the refractive index of air, which is the medium that exists between the objective lens 27 and the excitation light illumination position, the refractive index of the water W, and the refractive index of the specimen S, as well as the amount of movement by which the specimen S has moved in the optical-axis direction of the objective lens 27, as shown in FIG. 2.

Here, the refractive index of air is 1.0, and the refractive index of water is 1.33. In the water layer and the air layer, the shift in the focal position of the objective lens 27 is given by the thickness of the water layer×(Nd of water−1). Nd is the refractive index at a wavelength of 587.56 nm, which is called the d-line. In this embodiment, a calculation example is shown with 587.56 nm as a typical value; however, since the refractive index values of water and glasses differ depending on the wavelength that is actually used, it is necessary to use the refractive index value at the wavelength according to the purpose.

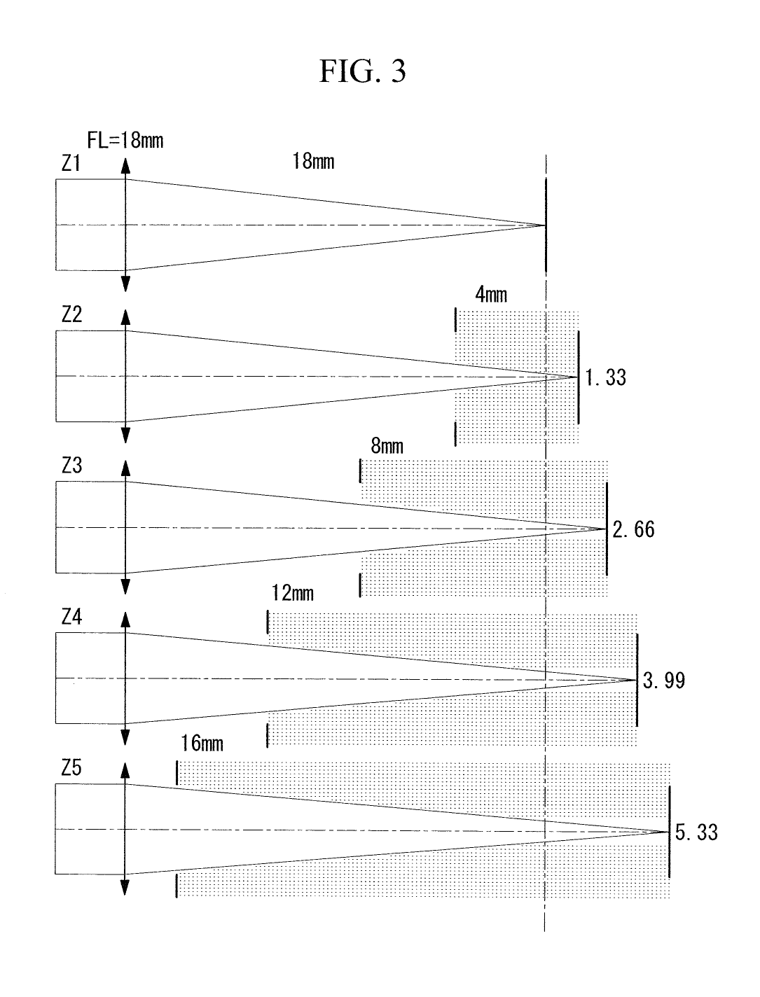

In other words, as shown in FIG. 3, in the case where the focal length (FL) of the objective lens 27 in air is 18 mm (see Z1 in FIG. 3), when a water layer with a thickness of 4 mm is interposed in that air, the focus position of the objective lens 27 is extended by 1.33 mm (see Z2 in the figure). In addition, in the case where the interposed water layer is 8 mm thick, the focus position of the objective lens 27 is extended by 2.66 mm (see Z3 in the figure); in the case where the interposed water layer is 12 mm thick, the focus position of the objective lens 27 is extended by 3.99 mm (see Z4 in the figure); and in the case where the water layer is 16 mm thick, the focus position of the objective lens 27 is extended by 5.33 mm (see Z5 in the figure). In other words, the focus position of the objective lens 27 changes by about 1.33 mm for every 4 mm thickness of the interposed water layer.

In addition, in this embodiment, the refractive index of the specimen S is 1.38, and if the refractive index of the specimen S can be considered identical to the refractive index of the water W, the water W layer and the specimen S layer can be regarded as a single layer.

Therefore, the amount by which the image-acquisition optical system 9 is moved in the optical-axis direction of the objective lens 27 is given by the amount of movement of the specimen S in the optical-axis direction of the objective lens 27×(Nd of water W−1).

The operation of the thus-configured fluorescence microscope 1 will be described below.

When performing fluoroscopy of the specimen S using the fluorescence microscope 1 according to this embodiment, for example, a plurality of tomographic images at different depths are obtained while changing the observation position in the optical-axis direction of the image-acquisition optical system 9 in the specimen S. First, the container 17 in which the specimen S is contained in water W is mounted on the stage 3, so that the objective lens 27 is disposed vertically above the specimen S so as to face the specimen S. Then, with the microscope control unit 3, the excitation light source 19 and the image-acquisition element 31 are operated, and sheet-like excitation light along the plane of incidence T is emitted from the excitation light source 19.

After the excitation light emitted from the excitation light source 19 is converted to substantially collimated light by the collimator lens 23, it is converted to sheet-like light by the cylindrical lens 25 and is incident on the specimen S in the container 17, along the horizontal plane of incidence T which is perpendicular to the optical axis P of the image-acquisition optical system 9. The excitation light being incident on the specimen S causes a fluorescent substance present in the region where the excitation light passes through to be excited, generating fluorescence.

Of the fluorescence generated in the specimen S, the fluorescence radiated in the optical-axis direction of the image-acquisition optical system 9 is collected by the objective lens 27, passes through the BA filter 29, and is imaged by the image-acquisition element 31. Accordingly, a fluorescence image in the specimen is obtained at the image acquisition element 31, and that fluorescence image is displayed on the monitor 15 via the image processing unit 13.

In this way, by causing the sheet-like excitation light along the plane of incidence T, which extends in the horizontal direction, to be incident on the specimen S, it is possible to illuminate, all at once, a wide region in a direction that intersects the optical axis P of the objective lens 27, which is disposed along the vertical direction, and it is possible to shorten the time required to obtain an image of a comparatively large specimen S.

Next, with the microscope control unit 33, the driving part is operated to change the height of the stage 3, and the specimen S is moved in the optical-axis direction of the objective lens 27 to obtain a tomographic image at the next observation position, which is different, in the depth direction of the specimen S.

When the specimen S is moved in the optical-axis direction of the objective lens 27, the proportions of the thicknesses of individual layers, along the optical-axis direction, of the media interposed from the objective lens 27 to the excitation-light illumination position in the optical-axis direction, namely, air, water W, and the specimen S, change; therefore, the focus position of the image-acquisition optical system 90 relative to the excitation light illumination position changes.

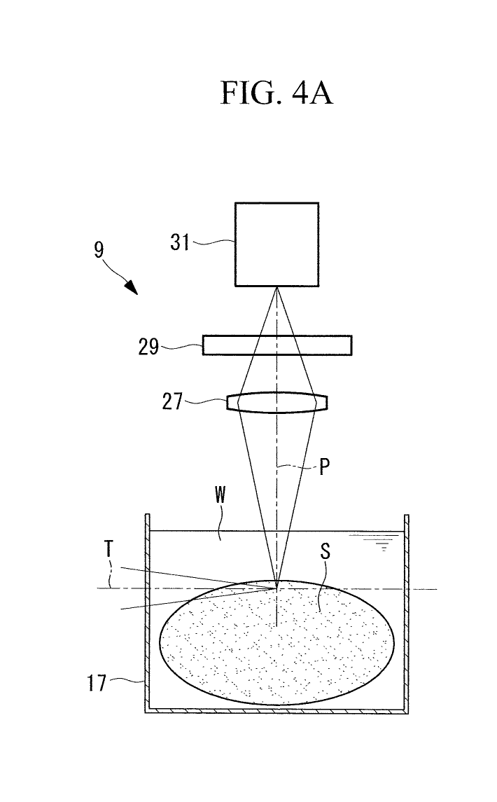

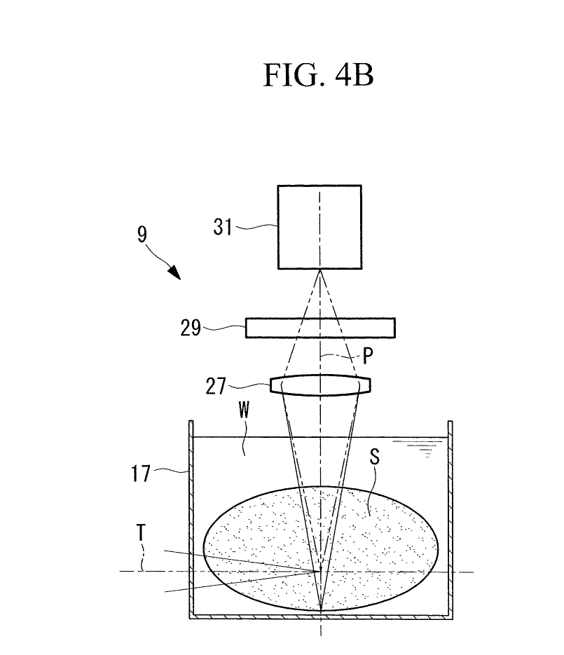

For example, a case can be considered in which, from the state in which the stage 3 is set at a low position, such that the excitation light illumination position and the focus position of the image-acquisition optical system 9 are coincident at the top of the specimen S, as shown in FIG. 4A, the stage 3 is raised so that the excitation light illuminates the bottom of the specimen S, as shown in FIG. 4B, and the specimen S is moved upward in the vertical direction. In this case, in the region from the objective lens 27 to the excitation light illumination position, the proportion of the thickness of the air layer, having a low refractive index, is smaller, and the proportion of the thickness of the specimen S layer, having a high refractive index, becomes correspondingly greater. As a result, the focus position of the image-acquisition optical system 9 relative to the excitation light illumination position is shifted in a direction in which the focus position of the image-acquisition optical system 9 becomes farther away from the objective lens 27.

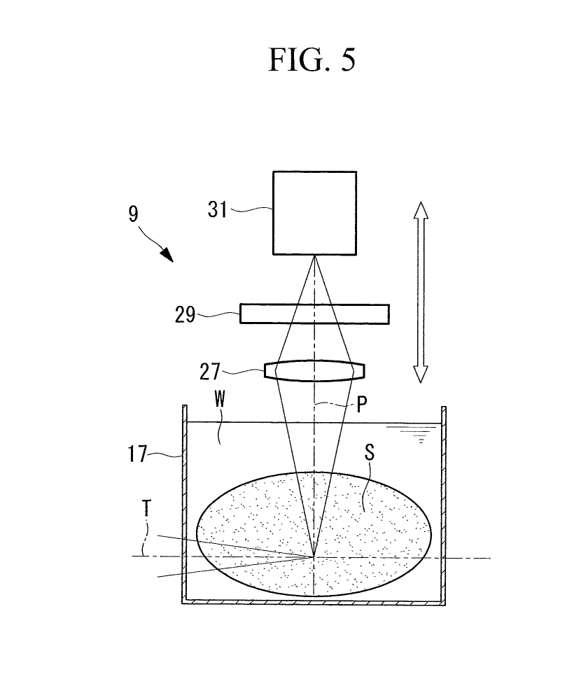

In this case, the amount of positional shift between the excitation light illumination position and the focus position. of the image-acquisition optical system 9 is calculated by the microscope control unit 33 from the refractive indices of the air, the water W, and the specimen S and the amount of movement by which the specimen S moves in the optical-axis direction of the objective lens 27. Then, with the microscope control unit 33, the image-acquisition optical system 9 is moved upward in the vertical direction by the calculated amount of positional shift, so that, as shown in FIG. 5, the positional shift between the excitation light illumination position and the focus position of the image-acquisition optical system 9 is corrected. Accordingly, it is possible to obtain a clear tomographic image also for the changed observation position.

On the other hand, when the position of the stage 3 is lowered to move the specimen S downward in the vertical direction, in the region from the objective lens 27 to the excitation light illumination position, the proportion of the thickness of the air layer, which has a small refractive index, increases, and the proportion of the thickness of the specimen S, which has a large refractive index, becomes correspondingly smaller. As a result, the focus position of the objective lens 27 approaches the focus position in the case where only air is present, and the focus position of the image-acquisition optical system 9 relative to the excitation light illumination position shifts in the direction towards the objective lens 27.

In this case, with the microscope control unit 33, the image-acquisition optical system 9 is moved downward in the vertical direction by the calculated amount of positional shift between the excitation light illumination position and the focus position of the image-acquisition optical system 9, so that the positional shift between the excitation light illumination position and the focus position of the image-acquisition system 9 is corrected.

As described above, with the fluorescence microscope 1 according to this embodiment, if the focus position of the image-acquisition optical system 9 relative to the excitation light illumination position changes due to the movement of the specimen S in the optical-axis direction of the objective lens 27, by correcting the positional shift between the excitation light illumination position and the focus position of the image-acquisition optical system 9 with the microscope control unit 33, it is possible to obtain a clear tomographic image even if the observation position in the specimen S in the optical-axis direction of the objective lens 27 is changed. Therefore, clear tomographic images of different positions in the optical-axis direction of the objective lens 27 can be obtained with sheet illumination, and it is possible to observe a larger specimen S.

In this embodiment it has been assumed that, when the positional shift between the excitation light illumination position and the focus position of the image-acquisition optical system 9 is corrected, the microscope control unit 33 moves the entire image-acquisition optical system 9 in the optical-axis direction; however, if the objective lens 27 and the image-acquisition element 31 are capable of being moved separately, it is acceptable to move only the objective lens 27 in the optical-axis direction.

In addition, although, in this embodiment, it has been assumed that the container 17 is filled with water W, instead of this, it may be filled with a solvent whose refractive index is known. In this case too, since the solvent penetrates the specimen S, and the refractive index of the specimen S is approximately the same as the refractive index of the solvent, the amount by which the image-acquisition optical system 9 is to be moved in the optical-axis direction should be calculated by taking the refractive index of the specimen S layer to be identical to the refractive index of the solvent layer.

Additionally, in this embodiment, it has been assumed that the amount of positional shift of the focus position of the image-acquisition optical system 9 relative to the excitation light illumination position is calculated to adjust the position of the image-acquisition optical system 9. Instead of this, for example, if the focus position of the image-acquisition optical system relative to the excitation light illumination position changes due to the movement of the specimen S in the optical-axis direction of the objective lens 27, the microscope control unit 33 may have an autofocus function that performs automatic focusing relative to the excitation light illumination position in the specimen S after it has moved.

In this case, for example, the contrast of the image obtained by the image-acquisition element 31 at each position while moving the objective lens 27 in the optical-axis direction may be compared in the image processing unit 13, and the microscope control unit 33 may adjust the position of the objective lens 27 so as to maximize the contrast.

By doing so, for example, when a solvent is used instead of water W, even if the refractive index of the solvent is not known, it is possible to correct the positional shift between the excitation light illumination position and the focus position of the image-acquisition optical system 9.

In addition, while moving the specimen S in the optical-axis direction of the objective lens 27, the focus position of the image-acquisition system 9 may be aligned with the excitation light illumination position, and the parameters may be recorded in advance. Then, when the focus position of the image-acquisition optical system 9 relative to the excitation light illumination position changes due to the movement of the specimen S in the optical-axis direction of the objective lens 27, the microscope control unit 33 may adjust the position of the objective lens 27 on the basis of those parameters.

With this modification, since the position of the objective lens 27 at which the excitation light illumination position and the focus position are aligned is known in advance, according to the position of the specimen. S in the optical-axis direction of the objective lens 27, the positional shift between the excitation light illumination position and the focus position of the image-acquisition optical system 9 can be corrected more rapidly.

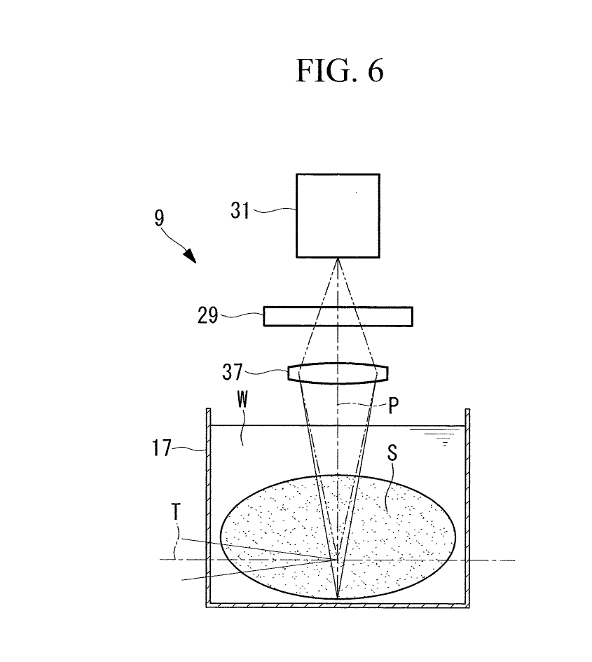

This embodiment may also be modified as follows. In this embodiment it has been assumed that, when the positional shift between the excitation light illumination position and the focus position of the image-acquisition system 9 is corrected, the position of the objective lens 27 is adjusted. As a first modification, as shown in FIG. 6, instead of the objective lens 27, a variable-focus lens 37 that has a liquid crystal device that can change the focus position of the image-acquisition optical system 9 by applying a voltage thereto may be employed. Then, when the focus position of the image-acquisition optical system relative to the excitation light illumination position changes due to the movement of the specimen S in the optical-axis direction of the objective lens 27, the microscope control unit 33 may control the voltage applied to the variable-focus lens 37 so that the focus position of the image-acquisition optical system 9 is aligned with the excitation light illumination position.

In this case, since it is not necessary to move the optical system, such as the variable-focus lens 37, in the optical-axis direction, light can be blocked for darkening the surroundings, thus facilitating observation.

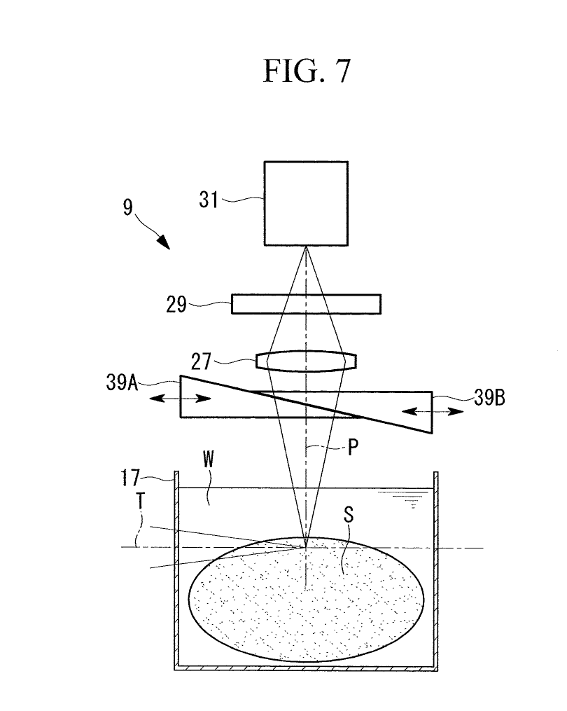

As a second modification, as shown in FIG. 7, a pair of wedge-shaped wedge members 39A and 39B formed of glass materials having different refractive indices according the to the thicknesses thereof may be provided, and these wedge members 39A and 39B may be disposed in an advancable/retractable manner in the light path between the objective lens 27 and the specimen S. Thus, when the focus position of the image-acquisition optical system 9 relative to the excitation light illumination position changes due to the movement of the specimen S in the optical-axis direction of the objective lens 27, the microscope control unit (wedge-member control unit) 33 may symmetrically move these wedge members 39A and 39B in a direction intersecting the optical axis of the objective lens 27, and may adjust the position at which the light collected by the objective lens 27 passes through each of the wedge members 39A and 39B so that the focus position of the image-acquisition optical system 9 is aligned with the excitation light illumination position.

For example, in the case where the thin parts of the pair of wedge members 39A and 39B are positioned facing each other, when the wedge members 39A and 39B are moved in directions so as to be separated from each other, the light passes through positions in the wedge members 39A and 39B where the refractive indices are smaller, and as a result, the focus position of the image-acquisition optical system 9 can be moved in a direction so as to approach the objective lens 27. In addition, when the wedge members 39A and 39B are moved in directions so as to become closer together, the light passes through positions in the wedge members 39A and 39B where the refractive indices are larger, and as a result, the focus position of the image-acquisition optical system 9 can be moved in a direction, so as to move away from the objective lens 27.

With this modification, the focus position of the image-acquisition optical system 9 changes in the axial direction of the objective lens 27 according to the thicknesses of the wedge members 39A and 39B at positions where the fluorescence collected by the objective lens 27 passes through the wedge members 39A and 39B, and therefore, it is possible to align the focus position of the image-acquisition optical system 9 with the excitation light illumination position simply by adjusting the positions of the pair of wedge members 39A and 39B.

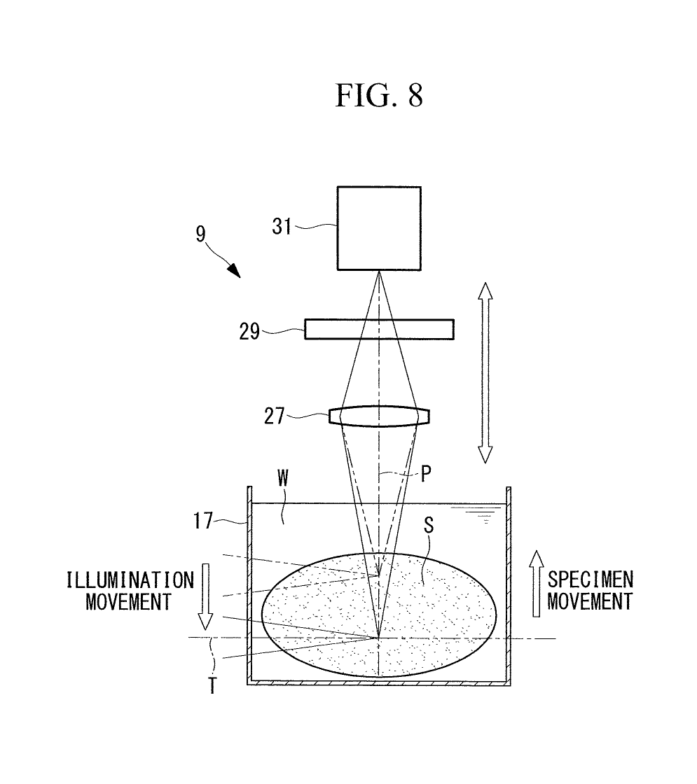

As a third modification, as shown in FIG. 8, when the focus position of the image-acquisition optical system 9 relative to the excitation light illumination position changes due to the movement of the specimen S in the optical-axis direction of the objective lens 27, the microscope control unit 33 may adjust the illumination position of the excitation light in the optical-axis direction of the objective lens 27 so that the excitation light illumination position is aligned with the focus position of the image-acquisition optical system 9.

In this case, the microscope control unit 33 may instruct the illumination-device control unit 35 so as to tilt the shifter 7 relative to the plane of incidence T of the excitation light and insert it in the light path, thereby adjusting the excitation light illumination position in the vertical direction. In addition, the sheet-illumination optical system 5 itself may be moved in the vertical direction to adjust the excitation light illumination position in the vertical direction.

With this modification, if the specimen S is moved in the optical-axis direction of the objective lens 27 by taking into consideration the amount of change in the focus position of the image-acquisition optical system 9 relative to the excitation light illumination position, it is possible to acquire clear images at desired observation positions simply by shifting the excitation light illumination position in the optical-axis direction of the objective lens 27 by an amount equal to the shift of the focus position of the image-acquisition optical system 9 relative to the excitation light illumination position.

### Second Embodiment

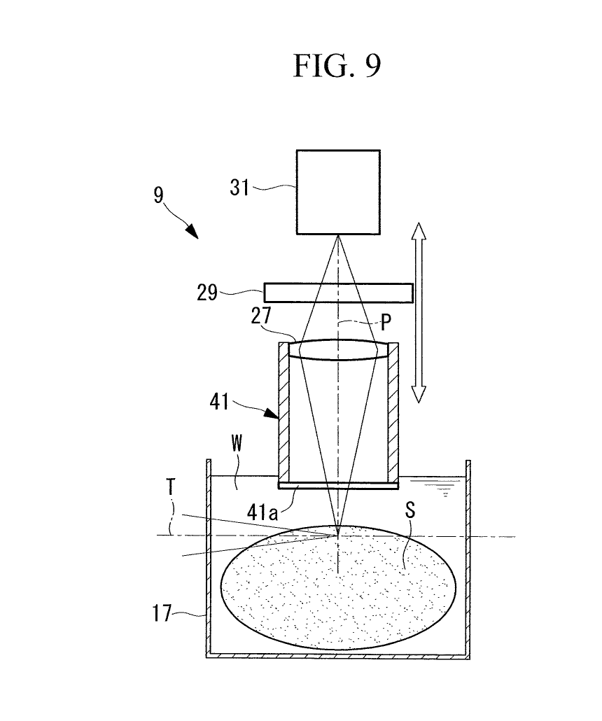

Next, a microscope apparatus according to a second embodiment of the present invention will be described with reference to FIG. 9.

The fluorescence microscope 1 according to this embodiment differs from the first embodiment in that a cap (proportion-maintaining part) 41 that is fitted on the objective lens 27 is provided, and in that the specimen S is observed in a state in which the cap 41 fitted on the objective lens 27 is inserted in the water W inside the container 17.

In the following, portions having the same configuration as those in the fluorescence microscope 1 according to the first embodiment are assigned the same reference signs, and a description thereof is omitted.

The cap 41 is a cylindrical member that is open at one end in the axial direction thereof and has a prescribed length in the axial direction. In addition, at the other end in the axial direction, the cap 41 has a window section 41a through which fluorescence from the specimen S can pass. This cap 41, by having the opening thereof fitted on the objective lens 27 and being disposed along the optical axis P of the objective lens 27, can form a fixed space that is sealed in the optical-axis direction from the objective lens 27.

The operation of the thus-configured fluorescence microscope 1 will now be described.

Observation of a specimen S with the fluorescence microscope 1 according to this embodiment is performed in a state in which the cap 41 fitted on the objective lens 27 is inserted in the water W inside the container 17. When the cap 41 is fitted on the objective lens 27, and the cap 41 is inserted into the water W in the container 17 in which the specimen S is contained, an air layer in which air is filled by means of the cap 41 and the water W and sample S layer are formed between the objective lens 27 and the excitation light illumination position.

Since the refractive index of the water W and the refractive index of the specimen S inside the container 17 are considered identical, as long as the objective lens 27 is moved together with the cap 41 in the optical-axis direction while the cap 41 is inserted in the water W, the proportions of the thickness of the air layer and the thickness of the water W and specimen S layer from the objective lens 27 to the excitation light illumination position do not change. In other words, with the cap 41, the proportions of the thicknesses, along the optical-axis direction, of the air layer and the water W and specimen S layer interposed between the objective lens 27 and the excitation light illumination position can be kept fixed, independently of the movement of the specimen S in the optical-axis direction of the objective lens 27.

Therefore, according to the fluorescence microscope 1 according to this embodiment, with a simple configuration in which the cap 41 is fitted on the objective lens 27 and observation is performed with the cap 41 inserted in the water W inside the container 17, a shift between the excitation light illumination position and the focus position of the image-acquisition optical system 9, due to the movement of the specimen S in the optical-axis direction of the objective lens 27, can be prevented, and clear image acquisition can be realized.

In this embodiment, although it has been assumed that the top of the container 17 is open, instead of this, the opening at the top of the container 17 may be closed off, and a lid for preventing the water surface from rippling may be provided. In this case, the lid is preferably of a type that is movable in the height direction of the water surface.

Although the embodiments of the present invention have been described above with reference to the drawings, the specific configuration is not limited to those embodiments, and design changes and the like within a range that does not depart from the scope of the present invention are also encompassed. For example, without limiting the present invention to the embodiments and modifications described above, the invention may also be applied to embodiments in which these embodiments and modifications are appropriately combined, and is not particularly limited.

### REFERENCE SIGNS LIST

1 fluorescence microscope
5 sheet-illumination optical system
9 image-acquisition optical system
17 container
27 objective lens
33 microscope control unit (positional-shift correction unit, wedge member control unit)
39A, 39B wedge member
41 cap (proportion-maintaining part)
T plane of incidence
P optical axis

1. A fluorescence microscope comprising:
a sheet-illumination optical system that causes sheet-like excitation light along a plane of incidence to be incident on a specimen;
an image-acquisition optical system that includes an objective lens having an optical axis intersecting the plane of incidence and that images fluorescence collected by the objective lens to obtain a fluorescence image;
a driving part that moves the specimen in the optical-axis direction of the objective lens; and
a positional-shift correction unit that, when a focus position of the image-acquisition optical system relative to an illumination position of the excitation light changes due to movement of the specimen in the optical-axis direction by the driving part, corrects a positional shift between the illumination position of the excitation light and the focus position of the image-acquisition optical system.

2. A fluorescence microscope according to claim 1, wherein the positional-shift correction unit adjusts the position of the objective lens in the optical-axis direction so that the focus position of the image-acquisition optical system is aligned with the illumination position of the excitation light.

3. A fluorescence microscope according to claim 1, wherein the objective lens is a variable-focus objective lens capable of changing the focus position of the image-acquisition optical system by application of a voltage, and the positional-shift correction unit controls the voltage applied to the variable-focus lens so that the focus position. of the image-acquisition optical system is aligned with the illumination position of the excitation light.

4. A fluorescence microscope according to claim 1, wherein the positional-shift correction unit includes a pair of wedge-shaped wedge members having different refractive indexes according to the thicknesses thereof and a wedge-member control unit that is capable of symmetrically moving the pair of wedge members in directions intersecting the optical axis of the objective lens, and
the wedge-member control unit adjusts positions at which the fluorescence collected by the objective lens passes through each wedge member so that the focus position of the image-acquisition optical system is aligned with the illumination position of the excitation light.

5. A fluorescence microscope according to claim 1, wherein the positional-shift correction unit adjusts the illumination position of the excitation light in the optical-axis direction so that the illumination position of the excitation light is aligned with the focus position of the image-acquisition optical system.

6. A fluorescence microscope comprising:
a sheet-illumination optical system that causes sheet-like excitation light along a plane of incidence to be incident on a specimen;
an image-acquisition optical system that includes an objective lens having an optical axis intersecting the plane of incidence and that images fluorescence collected by the objective lens to obtain a fluorescence image;
a driving part that moves the specimen in the optical-axis direction of the objective lens; and
a proportion-maintaining part that maintains constant proportions of the thicknesses, in the optical-axis direction, of a plurality of media having different refractive indices which are interposed between the objective lens and the illumination position of the excitation light, regardless of the movement of the specimen in the optical-axis direction by the driving part.

7. A fluorescence microscope according to claim 6, further comprising:
a container that can contain the specimen in a medium having a refractive index close to the refractive index of the specimen, wherein
the proportion-maintaining part is a cap through which. the fluorescence can pass, and which is fitted on the objective lens to form a fixed space in the optical-axis direction from the objective lens, and
the driving part moves the specimen in a state in which the cap is inserted in the medium in the container.
